(19) United States
(12) Patent Application Publication
(10) Pub. No.: US 2026/0367856 A1
(43) Pub. Date: Nov. 19, 2026

(54) SERVICE CONTROL SYSTEM, SERVICE CONTROL METHOD, AND RECORDING MEDIUM HAVING PROGRAM STORED THEREIN

(71) Applicant: NEC Corporation, Tokyo (JP)

(72) Inventors: Maki OOHASHI, Tokyo (JP); Sayuri OTERA, Tokyo (JP); Chikako NISHIMURA, Tokyo (JP); Motoyo TANAKA, Tokyo (JP)

(73) Assignee: NEC Corporation, Tokyo (JP)

(21) Appl. No.: 19/138,756

(22) PCT Filed: Dec. 5, 2023
(86) PCT No.: PCT/JP2023/043405

§ 371 Date: Jun. 13, 2025

(30) Foreign Application Priority Data
Dec. 23, 2022 (JP) 2022-207344

(51) Int. Cl. G06F 3/14; G06F 40/174; H04L 67/04

(52) U.S. Cl. CPC G06F 3/1454; H04L 67/04; G06F 40/174

(57) ABSTRACT

A service control system includes: an identifier for identifying, via a first terminal, a second terminal usable by a user when the online service is provided to the user; a communication controller for controlling connection from the second terminal to the online service; an input controller for enabling an input operation by the second terminal with respect to the online service; and a receiver for receiving the input operation from the second terminal.

### TECHNICAL FIELD

The present disclosure relates to a control technology of an input operation in an online service.

### BACKGROUND ART

Services are generally provided to consumers online in various business types such as financial, insurance, real estate, retail, and infrastructure. There are various kinds of forms of services provided online.

For example, PTL 1 discloses a technology related to a service for performing an insurance application procedure using a communication tool such as a web conference tool.

In relation to a form of providing an online service, PTL 2 discloses a technology of inserting a user graphic representation, which is an image indicating a user, into a virtual space of a virtual environment and performing communication between a plurality of users.

### Citation List

### Patent Literature

PTL 1: JP 2022-40022 A
PTL 2: JP 2022-42980 A

### SUMMARY OF INVENTION

### Technical Problem

In the service provided online, due to its nature, the opportunity for a user (for example, a customer) to perform various input operations increases. Therefore, the input operation by the user may be a burden on the user.

The present disclosure has been made in view of the above problems, and an object of the present disclosure is to provide a service control system and the like capable of improving convenience of input in an online service.

### Solution to Problem

A service control system according to an aspect of the present disclosure includes an identification means for identifying, via a first terminal, a second terminal available to a user when an online service is provided to the user, a communication control means for controlling connection from the second terminal to the online service, an input control means for enabling an input operation by the second terminal on the online service, and a reception means for receiving the input operation from the second terminal.

A service control method according to an aspect of the present disclosure includes identifying, via a first terminal, a second terminal available to a user when an online service is provided to the user, controlling connection from the second terminal to the online service, enabling an input operation by the second terminal on the online service, and receiving the input operation from the second terminal.

A program according to an aspect of the present disclosure causes a computer to execute the steps of identifying, via a first terminal, a second terminal available to a user when an online service is provided to the user, controlling connection from the second terminal to the online service, enabling an input operation by the second terminal on the online service, and receiving the input operation from the second terminal.

### Advantageous Effects of Invention

According to the present disclosure, it is possible to improve convenience of input in an online service.

### BRIEF DESCRIPTION OF DRAWINGS

FIG. 1 is a diagram schematically illustrating an example of a configuration including a service control system according to the first example embodiment.

FIG. 2 is a block diagram illustrating an example of a functional configuration of a service control system according to the first example embodiment.

FIG. 3 is a flowchart illustrating an example of an operation of the service control system of the first example embodiment.

FIG. 4 is a diagram schematically illustrating an example of a configuration of a service control system according to the second example embodiment.

FIG. 5 is a block diagram illustrating an example of a configuration of a service control system according to the second example embodiment.

FIG. 6 is a diagram illustrating an example of terminal information according to the second example embodiment.

FIG. 7 is a diagram illustrating an example of a notification according to the second example embodiment.

FIG. 8 is a diagram illustrating a first example of output information according to the second example embodiment.

FIG. 9 is a diagram illustrating a second example of output information according to the second example embodiment.

FIG. 10 is a diagram illustrating an example of output information output in a second terminal according to the second example embodiment.

FIG. 11 is a diagram illustrating a third example of output information according to the second example embodiment.

FIG. 12 is a sequence diagram illustrating an example of an operation of the service control system according to the second example embodiment.

FIG. 13 is a diagram illustrating another example of terminal information according to the fourth modification.

FIG. 14 is a block diagram illustrating an example of a configuration of a service control system according to the third example embodiment.

FIG. 15A is a diagram illustrating an example of output information output to a second terminal according to the third example embodiment.

FIG. 15B is a diagram illustrating another example of the output information output to the second terminal according to the third example embodiment.

FIG. 16 is a sequence diagram illustrating an example of an operation of a service control system according to a third example embodiment.

FIG. 17 is a block diagram illustrating an example of a hardware configuration of a computer device constituting a service control system according to each of the first, second, and third example embodiments of the present disclosure.

### EXAMPLE EMBODIMENT

Hereinafter, example embodiments of the present disclosure will be described with reference to the drawings.

### First Example Embodiment

An outline of a service control system according to the first example embodiment will be described.

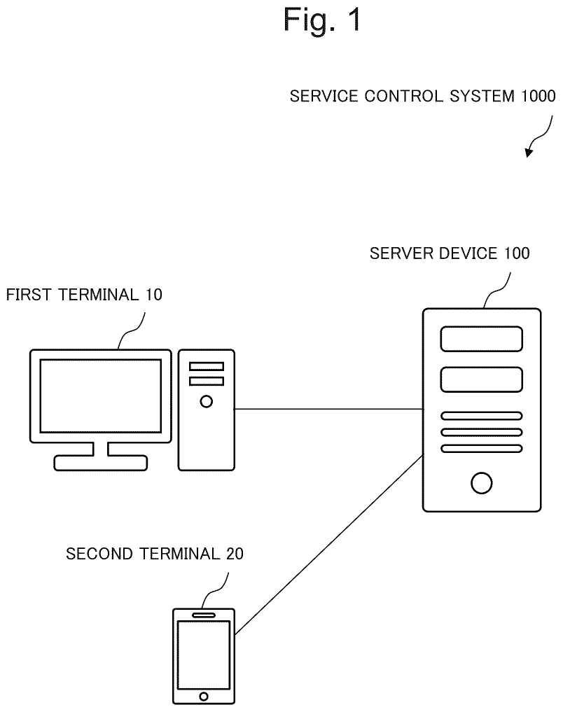

FIG. 1 is a diagram schematically illustrating an example of a configuration including a service control system 1000. The service control system 1000 may include at least a server device 100. In the example of FIG. 1, the service control system 1000 includes a first terminal 10, a second terminal 20, and the server device 100. The server device 100 is communicably connected to the first terminal 10 via a wireless or wired network. The server device 100 and the second terminal 20 can communicate with each other via a wireless or wired network.

In FIG. 1, the server device 100 is described as being configured by one device for convenience, but the configuration of the server device 100 is not limited to this example. That is, the server device 100 may include a plurality of devices.

The first terminal 10 and the second terminal 20 are terminals used by the user. The first terminal 10 and the second terminal 20 are, for example, personal computers. The first terminal 10 and the second terminal 20 may be portable terminals such as a smartphone and a tablet terminal. The first terminal 10 and the second terminal 20 include various input/output devices. Examples of the input/output device include a keyboard, a microphone, a camera, a display, and a speaker. The service control system 1000 may further include one or more terminals. That is, there may be a plurality of second terminals 20 that are terminals capable of communicating with the server device 100 and are terminals used by the user.

The first terminal 10 and the second terminal 20 are terminals having different functions or forms. For example, the first terminal 10 may be a laptop personal computer, and the second terminal 20 may be a smartphone. For example, the first terminal 10 and the second terminal 20 may have different data or different applications.

The user receives the provision of the online service using the first terminal 10. For example, the service may be provided by the server device 100. That is, the server device 100 may provide the online service to the user via the first terminal 10. The server device 100 may be, for example, a service server owned by a company that provides an online service.

Next, an example of a situation in which the service control system 1000 in the present application is used will be described. As an example of the situation, a situation in which the user inputs predetermined information when performing a predetermined procedure online is considered. At this time, the user receives the provision of the service via the first terminal 10. In this situation, communication is established between the server device 100 and the first terminal 10. On the other hand, communication may not be established between server device 100 and the second terminal yet. The situation of inputting the predetermined information is, for example, a situation of inputting personal information in a transaction with a financial institution, an insurance application, a product purchase, and the like. The situation of inputting the predetermined information is not limited to this example.

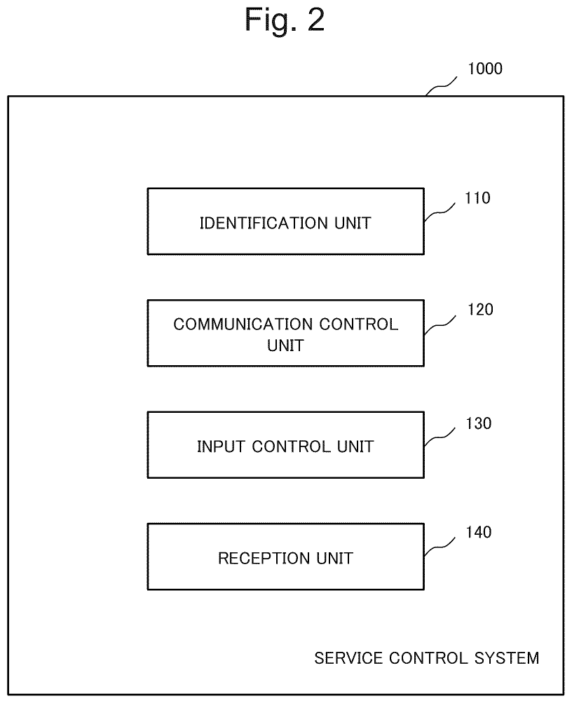

Next, an example of a functional configuration of the service control system 1000 will be described. FIG. 2 is a block diagram illustrating an example of a functional configuration of the service control system 1000. As illustrated in FIG. 2, the service control system 1000 includes an identification unit 110, a communication control unit 120, an input control unit 130, and a reception unit 140.

The identification unit 110 identifies the second terminal 20. Specifically, the identification unit 110 identifies a terminal different from the first terminal 10 used by the user in the online service. In a case where communication between the second terminal 20 and the server device 100 is not established, the identification unit 110 may identify the second terminal 20 using information stored in advance. For example, it is assumed that information related to the second terminal 20 and user identification information for identifying the user are stored in a storage device (not illustrated) in association with each other. At this time, the identification unit 110 may identify the second terminal 20 of the user based on the user identification information acquired from the first terminal 10.

In this manner, the identification unit 110 identifies the second terminal 20 available to the user. The identification unit 110 is an example of an identification means.

The communication control unit 120 controls communication between the server device 100 and the second terminal 20. Specifically, the communication control unit 120 controls connection to the online service from the second terminal 20. It is assumed that communication between the server device 100 and the second terminal 20 is not established when the user receives the provision of an online service via the first terminal 10. In this case, for example, the communication control unit 120 may establish communication using information that is stored in a storage device (not illustrated) and indicates a destination for connecting to the second terminal 20.

In this manner, the communication control unit 120 controls connection to the online service from the second terminal 20. The communication control unit 120 is an example of a communication control means.

The input control unit 130 performs control related to an input operation of the second terminal 20. The input control unit 130 may perform control to enable an input operation from the second terminal 20 in a situation where predetermined information is input. For example, it is assumed that the user wants to input text information in an online service. At this time, the input control unit 130 may enable the input operation of text information in the second terminal 20. For example, it is assumed that the user wants to input an image in an online service. At this time, the input control unit 130 may enable input of an image stored in the second terminal 20, or may activate a function of a camera included in the second terminal 20. The control example of the input control unit 130 is not limited to this example.

In this manner, the input control unit 130 enables the input operation on the online service by the second terminal 20. The input control unit 130 is an example of an input control means.

The reception unit 140 receives an input operation. Specifically, the reception unit 140 may receive an input operation in the second terminal 20. For example, it is assumed that an input form for inputting text information is displayed on the second terminal 20. In this case, the reception unit 140 may receive an input of text information to the input form. For example, it is assumed that the function of the camera of the second terminal 20 is activated by the input control unit 130. In this case, the reception unit 140 may receive an input of an image captured by the camera.

In this manner, the reception unit 140 receives an input operation on the online service in the second terminal 20. The reception unit 140 is an example of a reception means.

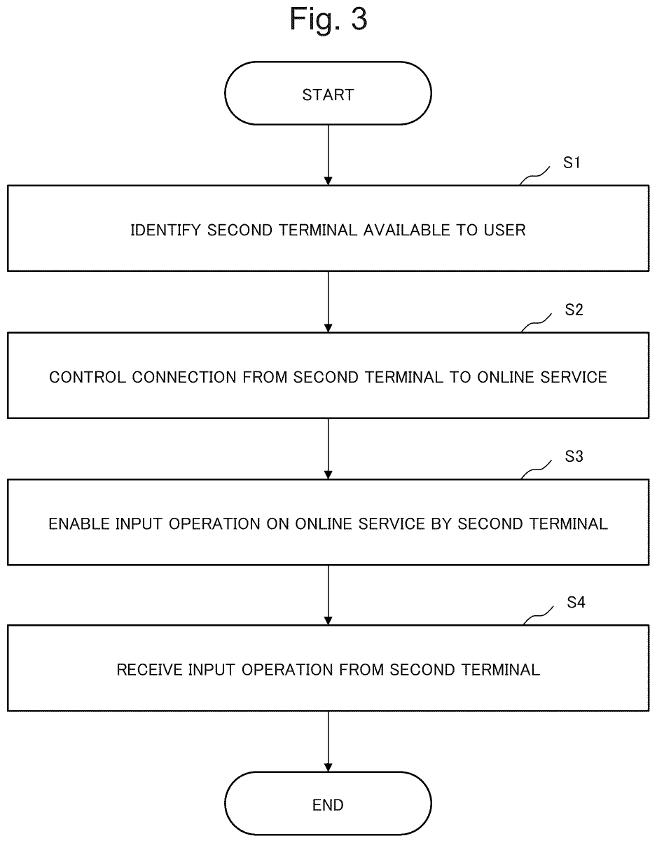

Next, an example of an operation of the service control system 1000 will be described with reference to FIG. 3. Note that, in the present disclosure, each step of the flowchart is represented using a number assigned to each step, such as “S1”.

FIG. 3 is a flowchart illustrating an example of the operation of the service control system 1000. In this operation example, it is assumed that the online service is provided by the server device 100 to the user via the first terminal 10.

The identification unit 110 identifies the second terminal 20 available to the user (S1). The communication control unit 120 controls connection to the online service from the second terminal 20 (S2). The input control unit 130 enables the input operation on the online service by the second terminal 20 (S3). The reception unit 140 receives an input operation from the second terminal 20 (S4).

As described above, the service control system 1000 according to the first example embodiment plays a role of at least part of the system in which the online service is provided to the user via the first terminal 10. The service control system 1000 identifies the second terminal 20 available to the user. The service control system 1000 controls connection from the second terminal 20 to the online service. Further, the service control system 1000 enables an input operation on the online service by the second terminal 20. The service control system 1000 receives an input operation from the second terminal 20.

As a result, when an online service is provided to the user via the first terminal 10, the service control system 1000 can receive an input operation from a terminal different from the first terminal 10.

For example, when text information is input, there may be a person who is good at input using a keyboard of a personal computer, or there may be a person who is good at input using a software keyboard of a smartphone. With the above configuration, the service control system 1000 of the present disclosure can input information by an input method desired by the user.

Different data may be stored depending on the terminal to be used. For example, it is assumed that there is a situation where personal information of the user is input. At this time, there is a possibility that the data of the personal information is not stored in the first terminal 10 but is stored in the second terminal 20. In such a case, when using the first terminal 10, the user is required to input personal information using a keyboard or the like. On the other hand, when using the second terminal 20, the user can also input personal information by copying and pasting the personal information stored in the second terminal 20. With the above configuration, the service control system 1000 of the present disclosure can also cause the user to perform input using information stored in a terminal different from the terminal used at the time of providing the online service.

There is a possibility that terminals used has different functions related to an input operation. For example, there is a possibility that a function of a camera, a function of an integrated circuit (IC) card reader, and the like are not provided in the first terminal 10 but are provided in the second terminal 20. With the above configuration, the service control system 1000 of the present disclosure can cause the user to perform input by a method that cannot be performed by the first terminal 10.

As described above, the service control system 1000 according to the first example embodiment can improve convenience of input in an online service.

### Second Example Embodiment

Next, a service control system according to the second example embodiment will be described. In a second example embodiment, a further example of the service control system described in the first example embodiment will be described. Part of the description of content overlapping with that of the first example embodiment will be omitted.

In the second example embodiment, a situation in which a user performs a procedure for a financial institution online will be described as an example. More specifically, the online service assumed in the second example embodiment is a service in which a screen is shared between a user and a staff member of a financial institution and procedures are performed while making a call or the like, like a web conference system. For example, the user connects to the online service using the first terminal 10. It is assumed that an input form for inputting predetermined information is displayed on the first terminal 10. The user can input information into the input form using the first terminal 10. In such a situation, the service control system 1000 is a system that enables the user to perform an input operation on the input form from a terminal different from the first terminal 10.

At this time, the server device 100 has a function of achieving a call between the first terminal 10 and a staff member terminal 30 to be described later. The call may be a call by only voice or a video call with a video. The server device 100 may have a function of sharing a screen between the first terminal 10 and the staff member terminal 30.

The user performs user registration in advance to use the online service. That is, in the service control system 1000, the account information of the user is registered in advance. The account information is, for example, user identification information such as a login identifier (ID) and a password. The account information may include further information. For example, the user may be able to connect to the online service by activating a dedicated application stored in the first terminal 10 and logging in using the account information. The user may be able to connect to the online service by activating a browser on the first terminal 10, accessing a website of a financial institution, and logging in using the account information.

A situation to which the service control system described in the second example embodiment is applied is not limited to the above example.

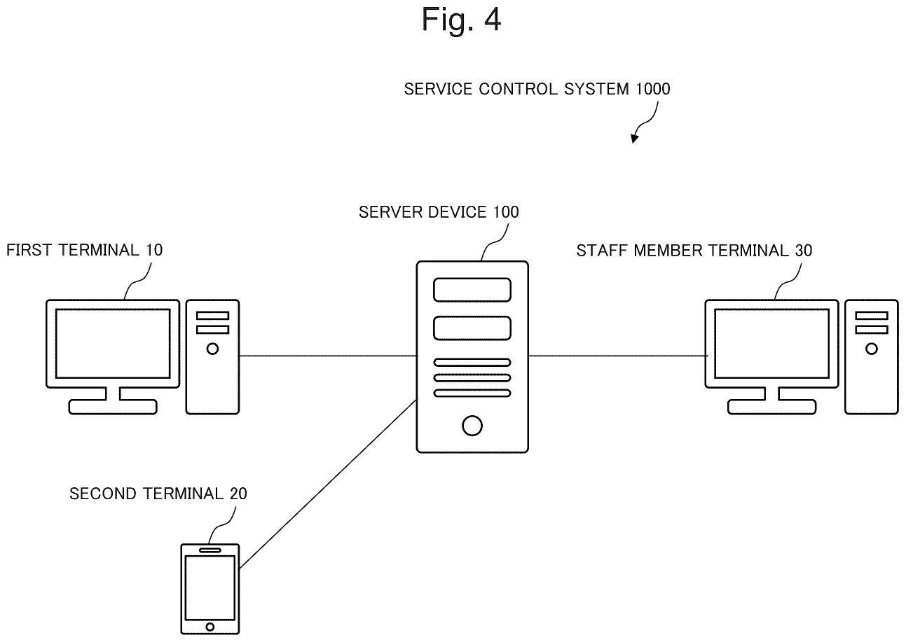

FIG. 4 is a diagram schematically illustrating an example of a configuration of a service control system 1000 according to the second example embodiment. The service control system 1000 includes the server device 100. In the example of FIG. 4, the service control system 1000 includes the server device 100, the first terminal 10, the second terminal 20, and the staff member terminal 30. The server device 100 can communicate with the first terminal 10, the second terminal 20, and the staff member terminal 30 via a network. The first terminal 10 and the second terminal 20 are terminals used by the user. The staff member terminal 30 is a terminal used by a staff member. In the present example embodiment, the “staff member” indicates a staff member of a financial institution, but the meaning of the “staff member” also changes depending on a situation where the service control system 1000 is applied. That is, the “staff member” may be a staff member of an organization that provides an online service.

### Details of Service Control System 1000

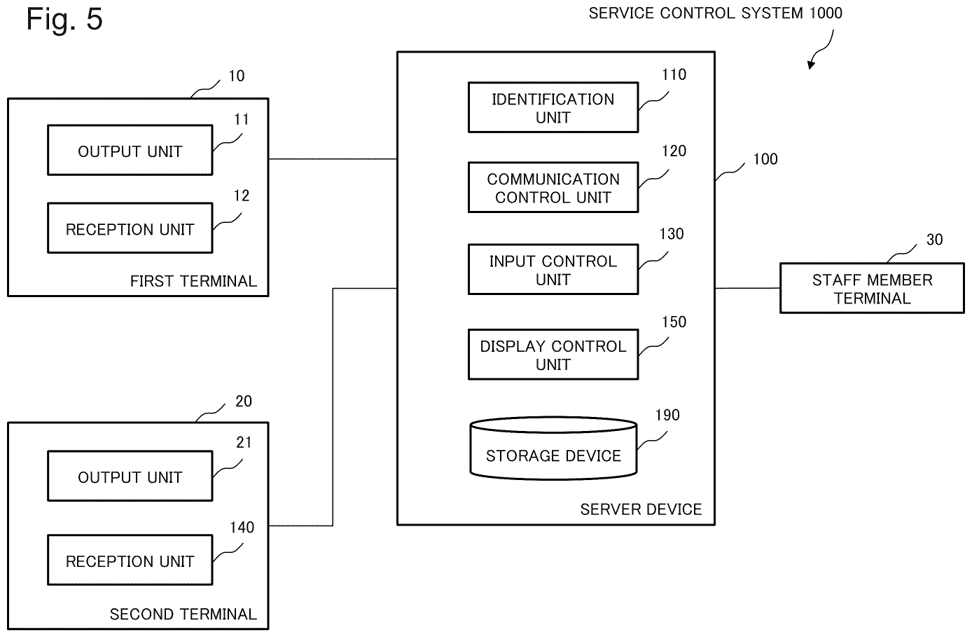

FIG. 5 is a block diagram illustrating an example of a configuration of the service control system 1000.

The first terminal 10 includes an output unit 11 and a reception unit 12. The second terminal 20 includes an output unit 21 and a reception unit 140. The output units 11 and 21 output various types of information. More specifically, information related to the online service, such as voice data, video data, and various screen information to be described later, is output. Each of the reception units 12 and 140 receives an operation from the user.

The server device 100 includes an identification unit 110, a communication control unit 120, an input control unit 130, and a display control unit 150. Furthermore, the server device 100 includes a storage device 190. The storage device 190 may be an external device communicably connected to the server device 100.

The identification unit 110 identifies a terminal available to the user in the online service. At this time, the identification unit 110 identifies an available terminal by using terminal information stored in the storage device 190. The terminal information indicates information about a terminal available to the user. The terminal information may be registered in advance. The terminal information is associated with the account information of the user.

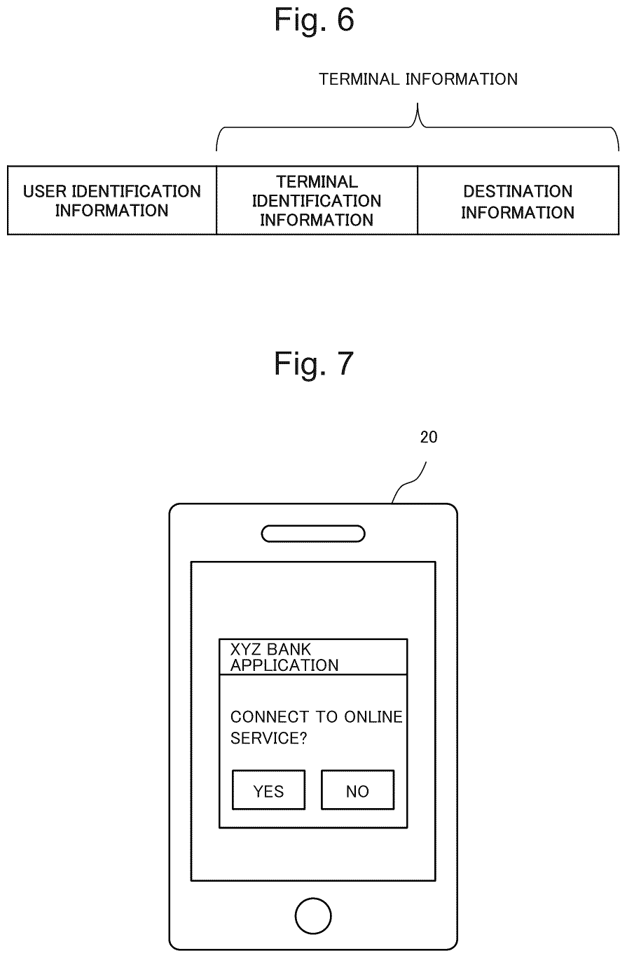

FIG. 6 is a diagram illustrating an example of terminal information. In the example of FIG. 6, the terminal information is associated with the user identification information. As illustrated in FIG. 6, the terminal information includes terminal identification information for identifying the terminal and destination information of the terminal. The destination information indicates a destination for connecting to the terminal. For example, it is assumed that an application of a financial institution exists in the terminal. At this time, the destination information may be information indicating the destination of the terminal individual used when the notification is made from the application. The information indicating the destination of the terminal individual is acquired, for example, by logging in to the application from the terminal. The destination information may be a mail address. When the terminal is a smartphone or the like, the destination information may be a telephone number.

The identification unit 110 identifies the second terminal 20 available to the user based on the account information of the user who has logged in to the system using the first terminal 10. In the example of FIG. 6, the identification unit 110 acquires user identification information of a user who receives the provision of the online service. The identification unit 110 identifies the second terminal 20 by identifying terminal information associated with the acquired user identification information. In this manner, the identification unit 110 may identify the terminal information including the destination information indicating the destination of the second terminal 20.

The method of acquiring the destination information is not limited to the above example. For example, the identification unit 110 may acquire the destination information from the first terminal 10 by the user's input.

The communication control unit 120 controls communication between the first terminal 10, the second terminal 20, and the staff member terminal 30 and the server device 100. More specifically, the communication control unit 120 controls connection of each of the first terminal 10, the second terminal 20, and the staff member terminal 30 to the online service.

For example, the communication control unit 120 has a function of achieving a call between the first terminal 10 and the staff member terminal 30. For example, the communication control unit 120 transmits the voice data and the video data captured by the staff member terminal 30 to the first terminal 10. The voice data in this case is a voice picked up by the microphone of the staff member terminal 30. For example, the voice data includes a voice uttered by a staff member. In addition, the video data is a video captured by a camera included in the staff member terminal 30. For example, the video data includes a video captured by the staff member. Similarly, the communication control unit 120 transmits the voice data and the video data captured by the first terminal 10 to the staff member terminal 30. The communication control unit 120 achieves a call between the first terminal 10 and the staff member terminal 30 by exchanging such data. The communication control unit 120 may similarly achieve a call between the second terminal 20 and the staff member terminal 30.

The communication control unit 120 connects to the online service of the second terminal 20. At this time, the communication control unit 120 uses the destination information included in the terminal information identified by the identification unit 110. Specifically, the communication control unit 120 notifies the destination indicated in the destination information of urging connection to the online service. The notification is, for example, information including a uniform resource locator (URL) for connecting to the online service.

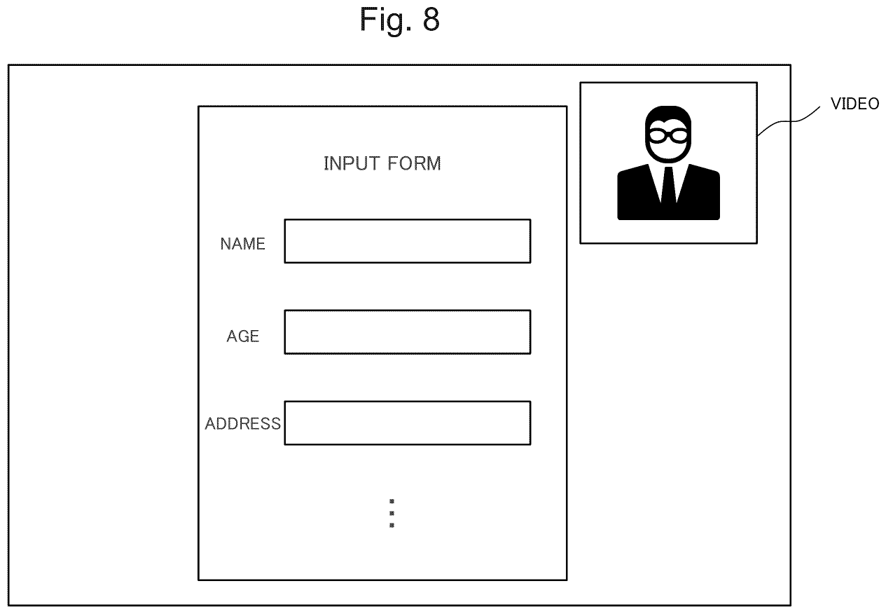

FIG. 7 is a diagram illustrating an example of a notification. FIG. 7 illustrates a screen of the second terminal 20 when a notification is given to the second terminal 20 which is a smartphone. For example, the communication control unit 120 performs push notification to the second terminal 20 using an application included in the second terminal 20. In the example of FIG. 7, a sentence asking whether to connect to the online service is displayed. In a case where the user selects “Yes”, the communication control unit 120 connects the second terminal 20 to the online service based on the URL included in the notification.

The notification method is not limited to this example. For example, the communication control unit 120 may make a notification by transmitting information including a URL or the like to the second terminal 20 using a mail and a short message service (SMS).

In this manner, the communication control unit 120 may notify the second terminal 20 of urging connection to the online service based on the destination information, and connect the second terminal 20 to the online service according to a response to the notification.

The input control unit 130 enables input operations on the online service of the first terminal 10, the second terminal 20, and the staff member terminal 30. For example, when the second terminal 20 is connected to the online service, the input control unit 130 performs control to enable input from the second terminal 20.

Furthermore, the input control unit 130 may control the input function of the terminal according to the type of information to be input to the online service. For example, it is assumed that text information is required to be input in a procedure for a financial institution. At this time, the input control unit 130 may activate the software keyboard of the second terminal 20. In a case where it is necessary to input an image or it is necessary to read code information such as a two-dimensional barcode, the input control unit 130 may activate the function of the camera of the second terminal 20. Further, in a case where the information of the IC card is required to be input, the input control unit 130 may activate a function of the IC card reader using a technique of near field communication (NFC) of the second terminal 20.

The display control unit 150 performs display control of information output in the online service. For example, the display control unit 150 displays output information including an input form or the like for inputting predetermined information on the first terminal 10 and the second terminal 20. The output units 11 and 21 output output information including various types of information under the control of the display control unit 150.

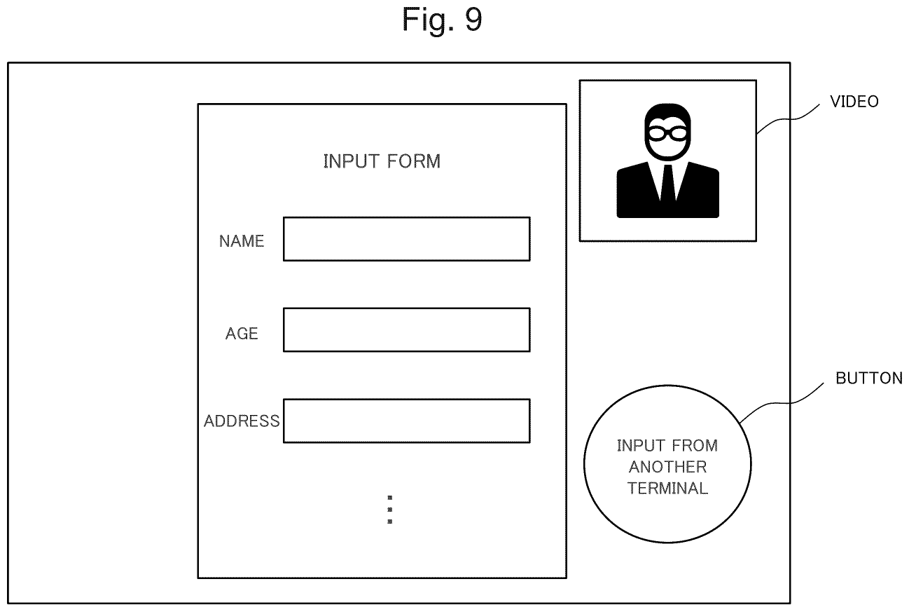

FIG. 8 is a diagram illustrating a first example of the output information. FIG. 8 illustrates an example of the output information displayed on the first terminal 10. In the example of FIG. 8, an input form prompting input of a name, an age, an address, and the like is displayed. For example, the user can perform an input operation on the input form using the first terminal 10. The reception unit 12 receives the input operation.

The output information is not limited to this example. For example, the output information may include information prompting input such as information about the purpose of procedures such as deposit and withdrawal, information about an account such as an account number, credit card information, IC card information, and the like. Furthermore, information prompting input of various images such as an image of an identification card may be included. The output information may include code information such as a two-dimensional barcode.

In the example of FIG. 8, a video showing the staff member is also displayed. The video is a video captured by the staff member terminal 30 controlled by the communication control unit 120. As described above, in the service control system 1000, it is possible to prompt the user to perform various inputs while the staff member and the user meet online.

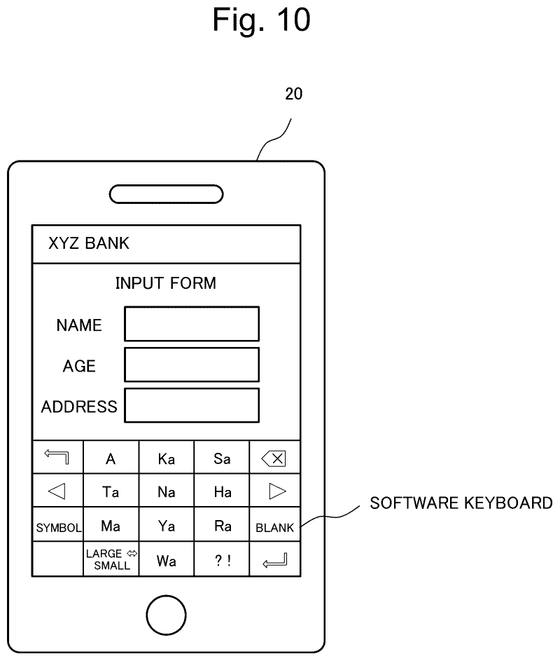

Furthermore, the display control unit 150 may display information for receiving a request for connection of the second terminal 20 to the online service on the first terminal 10. FIG. 9 is a diagram illustrating a second example of the output information. FIG. 9 illustrates a further example of the output information displayed on the first terminal 10. In the example of FIG. 9, a button describing “input from another terminal” is displayed. The button is an example of information for receiving a request for connection to the online service. For example, when the button is selected by the user, the server device 100 may perform control to enable an input operation from the second terminal 20. That is, the reception unit 12 receives a request for connection by selection of the button. When the request for connection is received, the identification unit 110 may identify the second terminal 20.

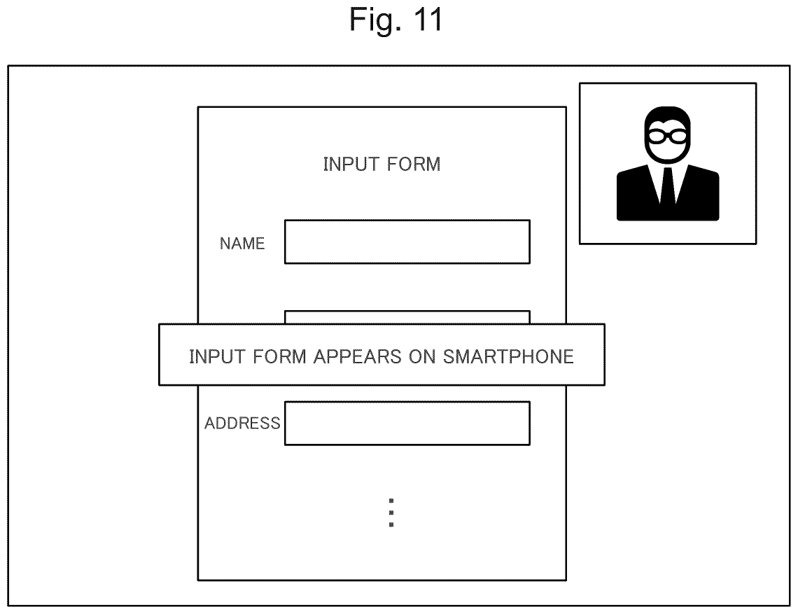

On the other hand, the display control unit 150 may display output information including an input form or the like for inputting predetermined information on the second terminal 20 connected to the online service. At this time, the display control unit 150 may perform display similar to the screen output in the first terminal 10 on the second terminal 20. The display control unit 150 may display at least information prompting input of predetermined information on the second terminal 20. FIG. 10 is a diagram illustrating an example of output information output in the second terminal 20. In the example of FIG. 10, an input form prompting input of information similar to the input form illustrated in FIG. 9 is displayed. Furthermore, in the example of FIG. 10, since it is necessary to input text information, a software keyboard is activated. In this manner, the display control unit 150 may display an input form having the content identical to that of the input form displayed on the first terminal 10 on the second terminal 20.

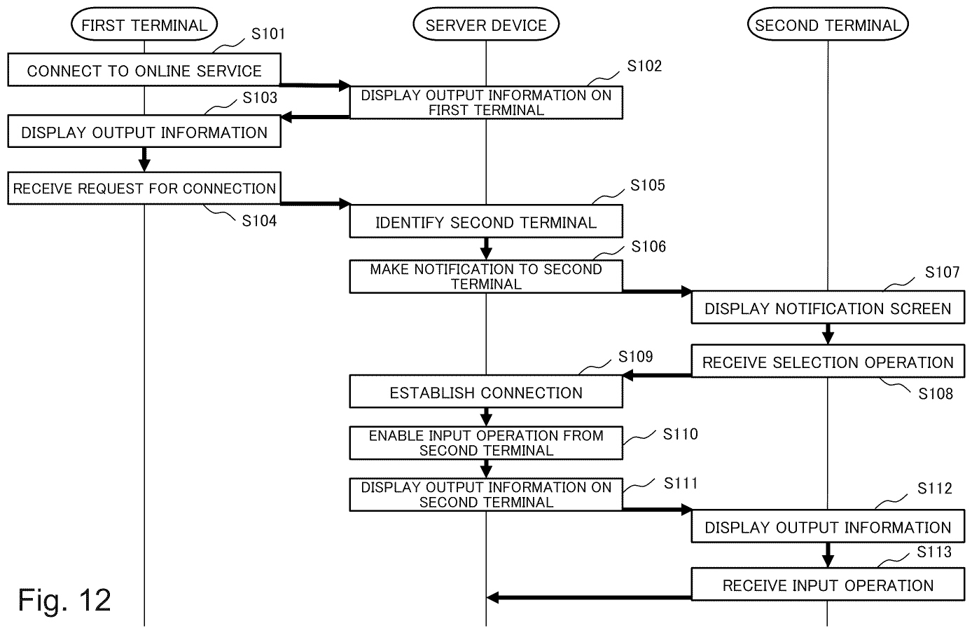

When the input operation is enabled in the second terminal 20, the display control unit 150 may display information indicating that the input operation is enabled on the first terminal 10. FIG. 11 is a diagram illustrating a third example of the output information. FIG. 11 is a further example of the output information displayed on the first terminal 10. In the example of FIG. 11, a sentence of “The input form has appeared on the smartphone” is displayed. As described above, when the input operation from the second terminal 20 is enabled, the display control unit 150 may display, on the first terminal 10, information indicating that the input operation from the second terminal 20 is enabled. As a result, it is possible to notify the user that the input operation from the second terminal 20 is enabled.

Operation example of Service Control System 1000

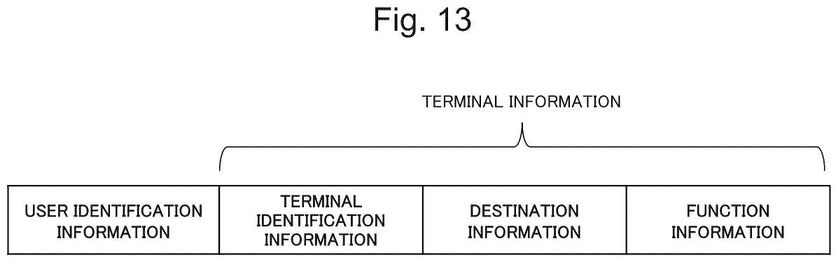

Next, an example of an operation of the service control system 1000 will be described with reference to FIG. 12. In the present operation example, a case where the user inputs text information from the second terminal 20 will be described.

FIG. 12 is a sequence diagram illustrating an example of the operation of the service control system 1000. First, the first terminal 10 connects to the online service (S101). For example, when the user logs in to a website or the like of a financial institution from the first terminal 10, the first terminal 10 connects to the online service. The display control unit 150 displays the output information output in the online service on the first terminal 10 (S102). The output unit 11 of the first terminal 10 outputs the output information (S103). For example, the output unit 11 outputs the output information of FIG. 9. That is, the output information includes information for receiving a request for connection to the online service.

In the first terminal 10, the reception unit 12 receives the request for connection from the user (S104). For example, the user selects the button illustrated in FIG. 9.

The identification unit 110 identifies the second terminal 20 available to the user (S105). For example, the identification unit 110 identifies user identification information indicated in the account information of the user. The identification unit 110 identifies terminal information associated with the user identification information. The communication control unit 120 makes a notification to the identified second terminal 20 (S106). For example, the communication control unit 120 makes a notification of encouraging connection to the online service using the destination information included in the terminal information.

The output unit 21 of the second terminal 20 displays the notification screen (S107). For example, the output unit 21 displays a screen as illustrated in FIG. 7. The reception unit 140 receives a selection operation (S108). Specifically, the reception unit 140 receives an operation of permitting connection to the online service from the user. In the example of FIG. 7, the reception unit 140 receives an operation of selecting “Yes”.

The communication control unit 120 establishes connection of the second terminal 20 to the online service (S109). The input control unit 130 enables the input operation from the second terminal 20 (S110). The display control unit 150 displays output information including an input form similar to that of the output information displayed on the first terminal 10 on the second terminal 20 (S111). The output unit 21 of the second terminal 20 displays the output information (S112). For example, the output unit 21 displays output information as illustrated in FIG. 10. At this time, the display control unit 150 may display, on the first terminal 10, information indicating that the input operation from the second terminal 20 is enabled as illustrated in FIG. 11.

The reception unit 140 receives an input operation from the user (S113). The input information is transmitted to the server device 100.

As described above, the service control system 1000 of the second example embodiment plays a role of at least part of a system in which an online service is provided to a user via the first terminal 10. The service control system 1000 identifies the second terminal 20 available to the user. The service control system 1000 controls connection from the second terminal 20 to the online service. Further, the service control system 1000 enables an input operation on the online service by the second terminal 20. The service control system 1000 receives an input operation from the second terminal 20.

As a result, when an online service is provided to the user via the first terminal 10, the service control system 1000 can receive an input operation from a terminal different from the first terminal 10.

For example, when text information is input, there may be a person who is good at input using a keyboard of a personal computer, or there may be a person who is good at input using a software keyboard of a smartphone. With the above configuration, the service control system 1000 of the present disclosure can input information by an input method desired by the user.

Different data may be stored depending on the terminal to be used. For example, it is assumed that there is a situation where personal information of the user is input. At this time, there is a possibility that the data of the personal information is not stored in the first terminal 10 but is stored in the second terminal 20. In such a case, when using the first terminal 10, the user is required to input personal information using a keyboard or the like. On the other hand, when using the second terminal 20, the user can also input personal information by copying and pasting the personal information stored in the second terminal 20. With the above configuration, the service control system 1000 of the present disclosure can also cause the user to perform input using information stored in a terminal different from the terminal used at the time of providing the online service.

There is a possibility that terminals used has different functions related to an input operation. For example, there is a possibility that a function of a camera, a function of an integrated circuit (IC) card reader, and the like are not provided in the first terminal 10 but are provided in the second terminal 20. With the above configuration, the service control system 1000 of the present disclosure can cause the user to perform input by a method that cannot be performed by the first terminal 10.

As described above, the service control system 1000 according to the second example embodiment can improve convenience of input in an online service.

The service control system 1000 according to the second example embodiment may identify terminal information including destination information indicating a destination of the second terminal 20. Then, the service control system 1000 may notify the second terminal 20 of urging connection to the online service based on the destination information, and connect the second terminal 20 to the online service according to a response to the notification. As a result, the service control system 1000 can reduce the burden on the user due to the operation for connecting the second terminal 20 to the online service.

The service control system 1000 according to the second example embodiment may have a function of displaying information output in the online service. Then, the service control system 1000 may display information for receiving a request for connection of the second terminal 20 to the online service on the first terminal 10, and identify the second terminal 20 when the request for connection is received.

As a result, the service control system 1000 can enable the input operation from the second terminal 20 at a timing desired by the user.

### First Modification

In the second example embodiment, an example in which the second terminal 20 is not connected to the online service in advance is described. On the other hand, the second terminal 20 may be connected to the online service in advance.

For example, when the user logs in to a website of a financial institution, the first terminal 10 is connected to an online service. In the second terminal 20, the user performs a similar operation to connect the second terminal 20 to the online service.

In this case, the identification unit 110 identifies the connected second terminal 20. The input control unit 130 enables an input operation by the identified second terminal 20. At this time, the user may not make a request for connection.

### Second Modification

When the input operation by the second terminal 20 is enabled, the input control unit 130 may disable the input operation by the first terminal 10.

### Third Modification

In the second example embodiment, the service control system 1000 controls the connection of the second terminal 20 to the online service in response to the reception of the request for connection from the user. The trigger for performing such connection control is not limited to this example.

For example, connection control may be performed by an operation of a staff member. For example, in the staff member terminal 30, a request for connection is made by an employee. In a case where the request for connection is made, the identification unit 110 may identify the second terminal 20.

### Fourth Modification

The service control system 1000 may identify the second terminal 20 according to the function of the second terminal 20.

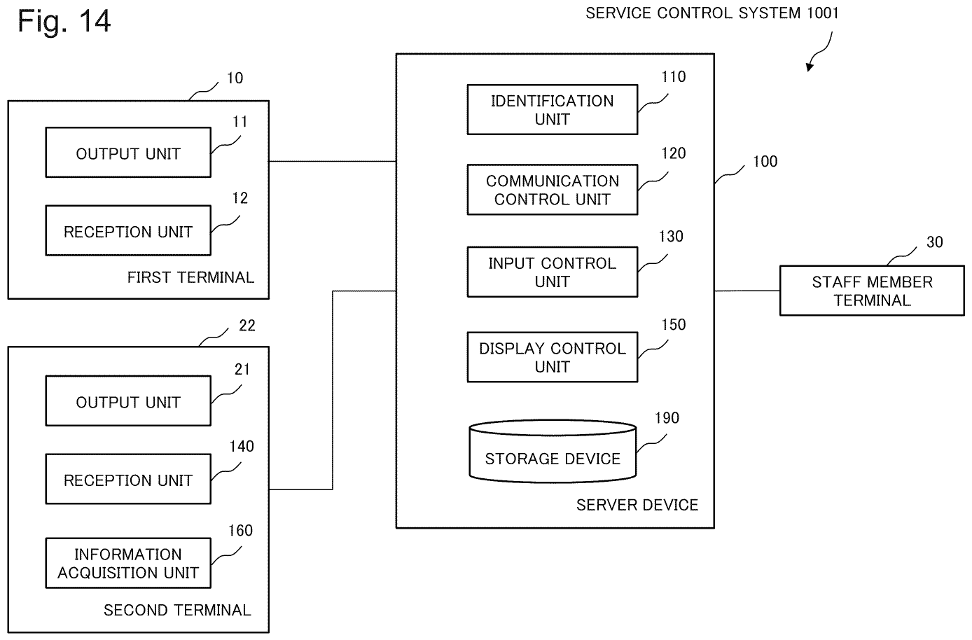

In this case, function information indicating the function of the terminal is stored in the storage device 190. FIG. 13 is a diagram illustrating another example of terminal information. As illustrated in FIG. 13, the terminal information may include function information. The function information includes, for example, information indicating the presence or absence of a software keyboard, the presence or absence of a camera, the presence or absence of an IC card reader, the presence or absence of a function of acquiring position information such as a global navigation satellite system (GNSS), and the like.

For example, as in the example of the second example embodiment, it is assumed that information about an IC card such as an Individual Number Card and a driver's license is necessary in a procedure for a financial institution. At this time, information included in an IC chip mounted on an IC card may be input. In such a case, it is necessary for the user to read the IC card.

In such a situation, the identification unit 110 may identify the second terminal 20 having the function of the IC card reader based on the function information.

That is, the service control system 1000 may identify a terminal having a function related to the type of information to be input as the second terminal 20.

### Third Example Embodiment

Next, a service control system according to the third example embodiment will be described. In a third example embodiment, a further example of an input operation in the second terminal will be described.

The description of part of the content overlapping with the content of the first example embodiment and the second example embodiment will be omitted.

Also in the third example embodiment, a situation in which a user performs a procedure for a financial institution online will be described as an example.

### Details of Service Control System 1001

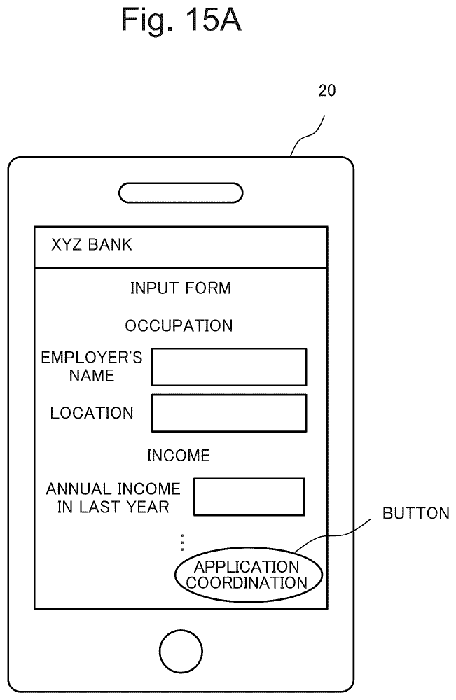

FIG. 14 is a block diagram illustrating an example of a configuration of a service control system 1001 according to the third example embodiment. As illustrated in FIG. 14, the service control system 1001 includes a server device 100, a first terminal 10, a second terminal 22, and a staff member terminal 30. The second terminal 22 is a terminal available to the user, as in the second terminal 20 of the second example embodiment. The second terminal 22 can communicate with the server device 100.

The second terminal 22 includes an output unit 21, a reception unit 140, and an information acquisition unit 160. The information acquisition unit 160 acquires the holding information from the application stored in second terminal 22. The holding information is information related to information to be input to the online service.

It is assumed that a procedure for a financial institution is a loan examination procedure. For example, information such as the occupation, income, and assets of the user may be required for the examination of the loan. That is, the user may be prompted to input information such as the occupation, income, and assets. In such a case, the information acquisition unit 160 acquires the occupation information about the occupation of the user, the income information about the income of the user, and the asset information about the assets owned by the user through the application stored in the second terminal 22. The job information, the income information, and the income information that can be acquired from the application are examples of the holding information.

For example, it is assumed that an application for managing income information and asset information is stored in the second terminal 22. Examples of the application include an application of asset management and an application of household accounts. At this time, the information acquisition unit 160 may acquire the income information, the asset information, and the like from the application.

It is assumed that an application for managing job information is stored in the second terminal 22. An example of the application is an application for managing a company ID card. At this time, the information acquisition unit 160 may acquire the job information from the application.

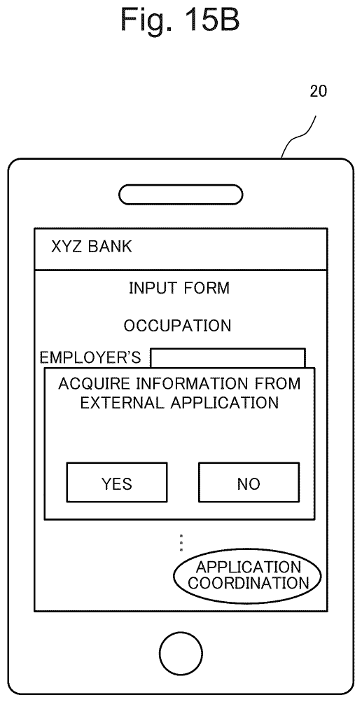

FIG. 15A is a diagram illustrating an example of output information output to the second terminal 22. For example, the output information including the input form as illustrated in FIG. 15A is displayed by the display control unit 150. At this time, a button describing “application cooperation” is displayed. When the user selects the button, the information acquisition unit 160 may start the processing. FIG. 15B is a diagram illustrating another example of the output information output to the second terminal 22. For example, when the user selects the button illustrated in FIG. 15A, a pop-up window as illustrated in FIG. 15B is displayed. When the user selects “Yes”, the information acquisition unit 160 performs a process of acquiring the holding information from another application that can cooperate with the online service.

In this manner, the information acquisition unit 160 acquires the holding information, which is information related to information to be input to the online service, from the application stored in the second terminal 22. The information acquisition unit 160 is an example of an information acquisition means.

The method of acquiring information is not limited to this example. For example, it is assumed that an application capable of performing a procedure related to an administrative service is stored in the second terminal 22. An example of the application is an application connectable to a system of a portal site capable of performing a procedure related to an administrative service using an Individual Number. Such a portal site can acquire basic four piece of information such as the user's name, age, address, gender, and the like, information about the user's income, information about the health insurance, and the like. For example, in a case where it is necessary to input information about the income, the information acquisition unit 160 acquires, as the holding information, the income information of the user from the external server providing the portal site via the application stored in the second terminal 22.

In recent years, there is a person whose occupation is to distribute a moving image or to advertise a product or service. In such a case, there is a possibility that information about various accounts such as the number of channel registrants of a video distribution site and the number of followers of a social networking service (SNS) affects the examination of the loan. In a case where such information about the account is input, the information acquisition unit 160 acquires the information about the account through the application of the video distribution site or the application of the SNS. For example, when the information about the number of channel registrants of the video distribution site is necessary, the information acquisition unit 160 acquires information about the user's account including the information about the number of channel registrants from an external server that provides the video distribution site through an application of the video distribution site.

In this manner, the information acquisition unit 160 may acquire the holding information acquired from the external server linked with the application.

The reception unit 140 receives an operation of inputting information included in the holding information acquired by the information acquisition unit 160.

### Operation Example of Service Control System 1001

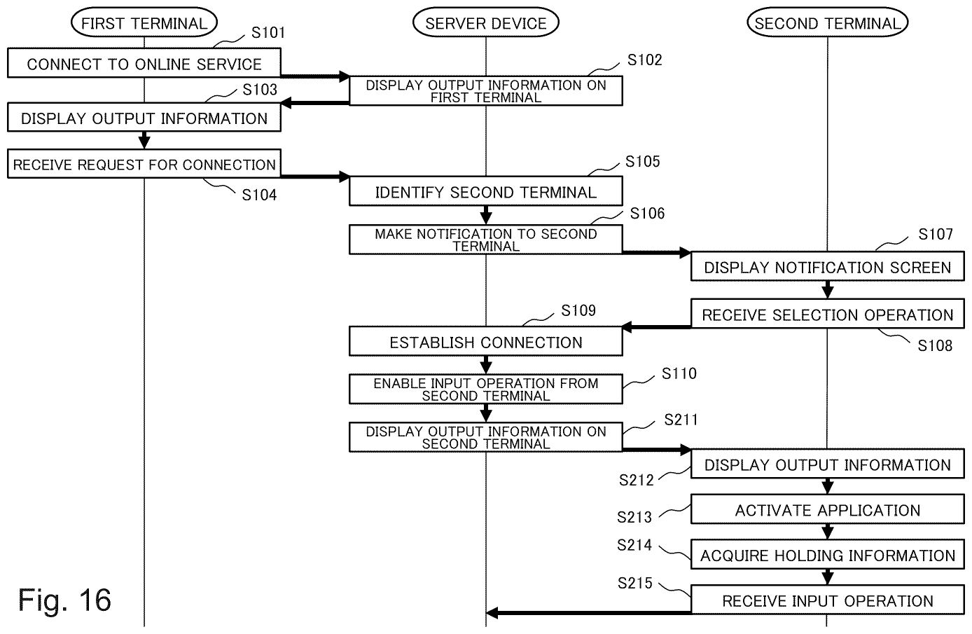

Next, an example of an operation of the service control system 1001 will be described with reference to FIG. 16.

FIG. 16 is a sequence diagram illustrating an example of the operation of the service control system 1001. In the example of FIG. 16, the processing of S101 to S110 is similar to that of the example of FIG. 12, and thus description thereof is omitted.

After the processing of S110, the display control unit 150 displays output information including an input form similar to that of the output information displayed on the first terminal 10 on the second terminal 22 (S211). The output unit 21 of the second terminal 22 displays the output information (S212). At this time, a button as illustrated in FIG. 15A may be displayed in the output information.

When the button is selected, the information acquisition unit 160 activates an application capable of acquiring holding information related to information to be input (S213). At this time, an application related to the online service provided in the server device 100 may be determined in advance. The information acquisition unit 160 acquires the holding information from the application (S214). At this time, the information acquisition unit 160 may acquire the holding information from a predetermined application.

The reception unit 140 receives an operation of inputting information included in the acquired holding information (S215).

As described above, the service control system 1001 of the third example embodiment may acquire the holding information, which is information related to the information to be input to the online service, from the application stored in the second terminal 22. Then, the service control system 1001 may receive an operation of inputting information included in the holding information.

As a result, the service control system 1001 can make an input to the online service based on the information stored in the second terminal 22 or the information acquirable from the second terminal 22, so that convenience of the input can be improved.

### Fifth Modification

The operation of the information acquisition unit 160 is not limited to the above example. For example, the information acquisition unit 160 may only perform a process of displaying a screen on which the holding information is described on the second terminal 22. In this case, the user performs an input operation by performing copy and paste from the screen.

### Sixth Modification

In the above-described example embodiment, the situation in which the procedure for the financial institution is performed online has been mainly described as an example. The service control system of the present disclosure is not limited to this example, and can be applied to various scenes.

For example, the service control system of the present disclosure is also applicable to a situation where online medical examination is performed.

In this situation, it is assumed that it is necessary to present a health insurance card. That is, the user may be prompted to input information about the health insurance card.

For example, in a case where it is necessary to input the image of the face of the health insurance card, the user photographs the health insurance card using the camera of the second terminal 22. The reception unit 140 receives an operation to input the captured image.

In a case where the Individual Number Card is used as a health insurance card, it is necessary to input an electronic certificate stored in an IC chip in the Individual Number Card. At this time, the user acquires the electronic certificate of the Individual Number Card using the IC card reader of the second terminal 22. The reception unit 140 receives an operation of inputting the acquired electronic certificate.

In online medical examination, input of a medication history may be prompted. In this case, for example, the information acquisition unit 160 acquires information about a medicine prescribed to the user from an application of a medicine notebook stored in the second terminal 22. The reception unit 140 receives an operation of inputting the acquired information about the medicine.

Furthermore, there is a case where input of health information or exercise information of the user is prompted in the online medical examination. The health information is, for example, information about pulse, blood pressure, body temperature, respiration, and the like of the user. The exercise information is information about the number of steps the user has walked, the amount of exercise, and the like. In this case, for example, the information acquisition unit 160 acquires the health information and the exercise information about the user from an application that manages the wearable terminal stored in the second terminal 22. More specifically, the information acquisition unit 160 acquires the health information and the exercise information acquired from the wearable terminal capable of measuring the health information and the exercise information by the application. The reception unit 140 receives an operation of inputting the acquired health information and exercise information.

### Seventh Modification

In the above-described example, an example in which the online service is a service using the web conference system has been mainly described, but the online service is not limited to this example.

For example, the online service may be a service provided on a website capable of performing various procedures without taking the form of a web conference. The online service may be a service in a virtual store using virtual reality or the like.

### Hardware Configuration of Service Control System

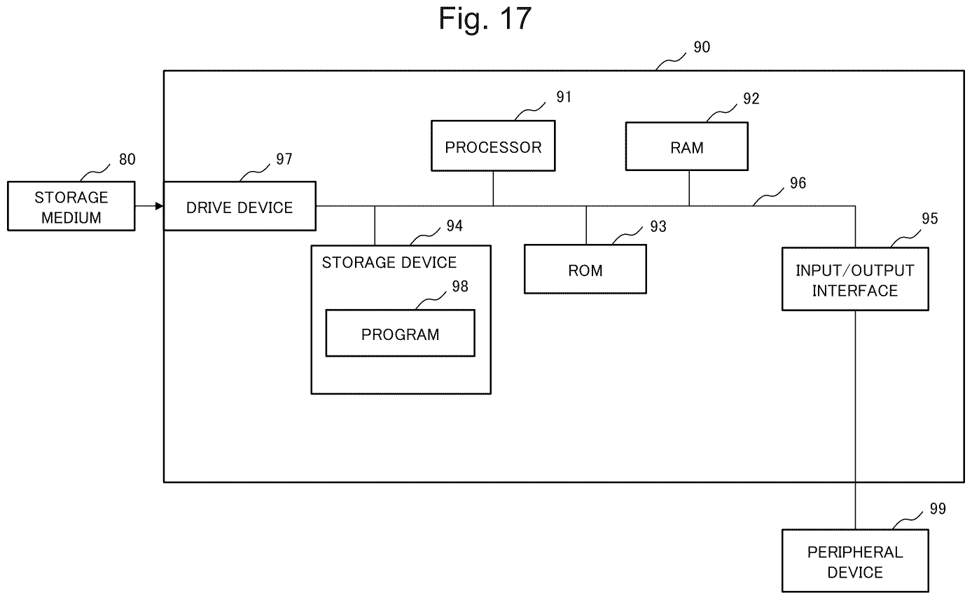

Hardware constituting the service control system of the first, second, and third example embodiments described above will be described. FIG. 17 is a block diagram illustrating an example of a hardware configuration of a computer device constituting a service control system according to each example embodiment. In a computer device 90, the service control system and the service control method described in each example embodiment and each modification are achieved. For example, each of the server device, the first terminal, the second terminal, and the like described in each example embodiment and each modification may have the hardware configuration illustrated in FIG. 17.

As illustrated in FIG. 17, the computer device 90 includes a processor 91, a random access memory (RAM) 92, a read only memory (ROM) 93, a storage device 94, an input/output interface 95, a bus 96, and a drive device 97. The service control system may be implemented by a plurality of electric circuits.

The storage device 94 stores a program (computer program) 98. The processor 91 executes the program 98 of the service control system by using the RAM 92. Specifically, for example, the program 98 includes a program that causes a computer to execute the processing illustrated in FIGS. 3, 12, and 16. A function of each configuration of the service control system is implemented in response to the processor 91 executing the program 98. The program 98 may be stored in the ROM 93. The program 98 may be recorded in a storage medium 80 (recording medium) and read using the drive device 97, or may be transmitted from an external device (not illustrated) to the computer device 90 via a network (not illustrated).

The input/output interface 95 exchanges data with a peripheral device (keyboard, mouse, display device, etc.) 99. The input/output interface 95 functions as a means for acquiring or outputting data. The bus 96 connects the respective components.

There are various modifications of the method of implementing the service control system. For example, each configuration included in the service control system can be achieved as a dedicated device. The service control system can be achieved based on a combination of a plurality of apparatuses.

A processing method of causing a storage medium to record a program for achieving each configuration in the functions of each example embodiment, reading the program recorded in the storage medium as a code, and a computer executing the program are also included in the scope of each example embodiment. That is, a computer-readable storage medium is also included in the scope of each example embodiment. A storage medium recording the above-described program and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. In addition, the program recorded in the storage medium is not limited to a program that executes processing by itself, and programs that operate on an operating system (OS) to execute processing in cooperation with other software and functions of an extension board are also included in the scope of each example embodiment.

Although the present invention is described above with reference to the example embodiments, the present invention is not limited to the above example embodiments. It will be understood by those of ordinary skill in the art that various changes in form and details may be made therein without departing from the spirit and scope of the present invention as defined by the claims.

The above-described example embodiments and modifications can be appropriately combined.

This application claims priority based on Japanese Patent Application No. 2022-207344 filed on Dec. 23, 2022, the entire disclosure of which is incorporated herein.

### REFERENCE SIGNS LIST

10 first terminal
11, 21 output unit
20, 22 second terminal
30 staff member terminal
100 server device
110 identification unit
120 communication control unit
130 input control unit
12, 140 reception unit
150 display control unit
160 information acquisition unit
190 storage device

What is claimed is:

1. A service control system comprising:
when an online service is provided to a user via a first terminal,
an identifier configured to identify a second terminal available to a user;
a communication controller configured to control connection from the second terminal to the online service;
an input controller configured to enable an input operation by the second terminal to the online service; and
a receiver configured to receive the input operation from the second terminal.

2. The service control system according to claim 1, wherein
the identifier identifies terminal information including destination information indicating a destination of the second terminal, and
the communication controller notifies the second terminal of prompting connection to the online service based on the destination information, and causes the second terminal to be connected to the online service according to a response to the notification.

3. The service control system according to claim 1, further comprising
a display controller configured to display information output in the online service, wherein
the display controller displays information for receiving a request for connection of the second terminal to the online service on the first terminal, and
the identifier identifies the second terminal when the request for connection is received.

4. The service control system according to claim 3, wherein
the display controller displays information indicating that the input operation from the second terminal is enabled on the first terminal when the input operation from the second terminal is enabled.

5. The service control system according to claim 1, further comprising
a display controller configured to display information output in the online service, wherein
the display controller displays, on the second terminal, an input form having content identical to content of an input form displayed on the first terminal.

6. The service control system according to claim 1, wherein
the input controller controls an input function of the second terminal according to a type of information to be input to the online service.

7. The service control system according to claim 1, further comprising
an information acquisitor configured to acquire holding information from an application stored in the second terminal, the holding information being information related to information to be input to the online service, wherein
the receiver receives an operation of inputting information included in the holding information.

8. The service control system according to claim 7, wherein
the information acquisitor acquires the holding information acquired from an external server that cooperates with the application.

9. A service control method, comprising:
when an online service is provided to a user via a first terminal,
identifying a second terminal available to the user;
controlling connection from the second terminal to the online service;
enabling an input operation by the second terminal to the online service; and
receiving the input operation from the second terminal.

10. A tangible and non-transitory recording medium storing a program for causing a computer to execute the steps of:
when an online service is provided to a user via a first terminal,
identifying a second terminal available to the user;
controlling connection from the second terminal to the online service;
enabling an input operation by the second terminal to the online service; and
receiving the input operation from the second terminal.
